(19) United States
(12) Patent Application Publication
(10) Pub. No.: US 2005/0074305 A1
(43) Pub. Date: Apr. 7, 2005

(54) Micro-adjustable boring bar

(76) Inventor: Hsin-Tien Chang, Taichung Hsien (TW)

Correspondence Address: CHARLES E. BAXLEY, ESQ., 90 JOHN STREET, THIRD FLOOR, NEW YORK, NY, 10038, US

(21) Appl. No.: 10/680,061

(22) Filed: Oct. 6, 2003

(51) Int. Cl. B23B 29/00

(52) U.S. Cl. 408/150

(57) ABSTRACT

The present invention provides a micro-adjustable boring bar, which includes boring bar body and an adapter, wherein said adapter has a micro-eccentric bore set upon one end for plugging in the boring bar body with the pivoting shaft, and a V-shaped ring groove is built upon the proper position of said pivoting shaft of the boring bar body, coordinating to said V-shaped ring groove, the adapter has a securing threaded hole and a locating threaded hole built on, therein said securing threaded hole is built on opposite side of the eccentric side of the micro-adjustment bore, said locating threaded hole is used to hold an elastic limiting block in, by securing the screw in, the elastic limiting block can generate an upward elastic force to push the pivoting shaft of boring bar body upward to touch against the adapter more tightly and improve the combined assembly's rigidity; by means of the eccentric design, turning the boring bar body in the micro-adjustment bore of the adapter can move the tip end of the cutter tool to change the boring size of the hole in positive or negative for increasing or decreasing the size of boring hole, and whatever turning the boring bar body in which direction for micro-adjusting, the dynamic balance will be kept in constant without any resetting dynamic balance.

### BACKGROUND OF THE INVENTION

1. Field of the Invention

The present invention relates to a micro-adjustable boring bar, and refers more specifically to the micro-adjusting mechanism based on the eccentric principle, thereby composite a micro-adjustable boring bar with high rigid, good balance as with along the fine adjustment of the boring cutter, on the other hand, some safety devices attached on it for preventing the adjustment from overpass safety limitation, and the boring cutter from damage occurred by loosing the fastening screw.

2. Description of Prior Art

In accordance with the conventional micro-adjustable boring bar 10, as shown in FIG. 11, the fine adjustment device is comprised of a trimming screw 11, an arbor nut 12 and an arbor 13, by adjusting said trimming screw 11, the tip position of the tool bit 14 is changed further, so as to get fine adjustment of the size of bored hole, on the other hand a balance device is set upon above the fine adjustment device, said balance device includes a screw stem 15 and a balance nut 16. When fine adjusting the boring hole in each time, for getting the dynamic balance of adjusted boring bar 10, the balance nut 16 has to be repetitively adjusted according to the experiment values on the adjustment list provided by the manufacturer of the boring tool as a reference, therefore adjusting the balance nut 16 referring to the adjustment list is an essential process after fine adjusting the boring hole size in each time so as to getting or approaching to the dynamic balance for preventing the boring hole from noncircular in high-spin cutting, so the balance adjustment has to take a certain time, meanwhile the number of checking circular of the boring hole has to be increased, these are the main shortcomings of the prior art. Additionally, said micro-adjustable boring bar 10 costs about USD$600, especially to multiple holes processing, a relative number of the micro-adjustable boring bars have to be prepared; it is a huge cost to the manufacturer, so it is another shortcoming.

### OBJECTS AND SUMMARY OF THE INVENTION

It is therefore a main object of the present invention to provide a micro-adjustable boring bar without any balance adjustment as adjusting the size of said boring hole, further saving process time and decreasing production cost.

For achieving said object, the present invention is to provide a micro-adjustable boring bar, based on the micro-eccentric principle, in which an adapter provides with an eccentric bore at one terminal end there-through which has a longitudinal axis which is parallel to but offset about 0.1 mm from the axis of said adapter for plugging in the back shaft of the boring bar body member. Said back shaft is provided with a V-shaped ring groove on the middle facing to the radial fastening thread-hole and the locating thread-hole of said adapter exactly as combining together in place, by means of an elastic locating block, the back shaft is pushed upward to against the adapter tightly, and additionally is retained by securing fastening screw and a pad with a cambered top surface, so that said boring bar body is locked in said adapter at both orientations—radial and axial tightly and rigidly; by turning the bar shaft in the eccentric bore, the distance between the tip end of the cutter edge and the rotation axis is micro-changed, so that the goal of micro-adjustment of the size of the boring hole is reached, meanwhile the fastened boring bar assembly is kept in the dynamic balance forever without any change as micro-adjusting the size of boring hole.

By means of the micro-eccentric bore, turning the boring bar shaft an angle around the rotation axis can change the distance from the tip end of the cutter edge to the rotation axis to correct the size of the boring hole in positive or negative; on the other hand, whatever the boring bar shaft is turned in clockwise or anticlockwise, the dynamic balance of said assembled boring bar set is constant, in the other word, the dynamic balance of the boring bar shaft will not be changed, therefore as micro-adjusting the size of boring hole the dynamic balance will not be reset, so the present invention has excellent practicality, and simplifies the procedure of boring hole greatly. More specially, a pair of limited points is set upon the adapter, even if the boring bar shaft has not been fastened yet when the machine is cut on, the boring bar shaft is automatically turned to the minimal size position, thereby preventing the cutting bit form striking on the boring hole rim without any anxiety about damaging boring bar, further to protect the cutting bit under the boring bar shaft unlocked situation.

### BRIEF DESCRIPTION OF THE DRAWINGS

FIG. 1 is an exploded view of the present invention.

FIG. 2 is a cross-section view of the present invention.

FIG. 3 is a radial cross-section view of the present invention.

FIG. 4 is a part enlarged view showing elastic locating block locating the boring bar shaft of the present invention.

FIG. 5 is a topside view showing the tip end of cutter edge at homing position of the present invention.

FIG. 6 is a topside view showing the tip end of the cutter edge at maximal limitation in cutting size of the present invention.

FIG. 7 is a topside view showing the tip end of the cutter edge at minimal limitation in cutting size of the present invention.

FIG. 8 is a topside view showing the adjustment at the positive limitation of present invention.

FIG. 9 is a topside view showing the adjustment at the negative limitation of present invention.

FIG. 10 is a side view showing the embodiment with HSK63A tapering spindle of the present invention.

FIG. 11 is a schematic of the prior art.

### DETAILED DESCRIPTION OF PREFERRED EMBODIMENTS

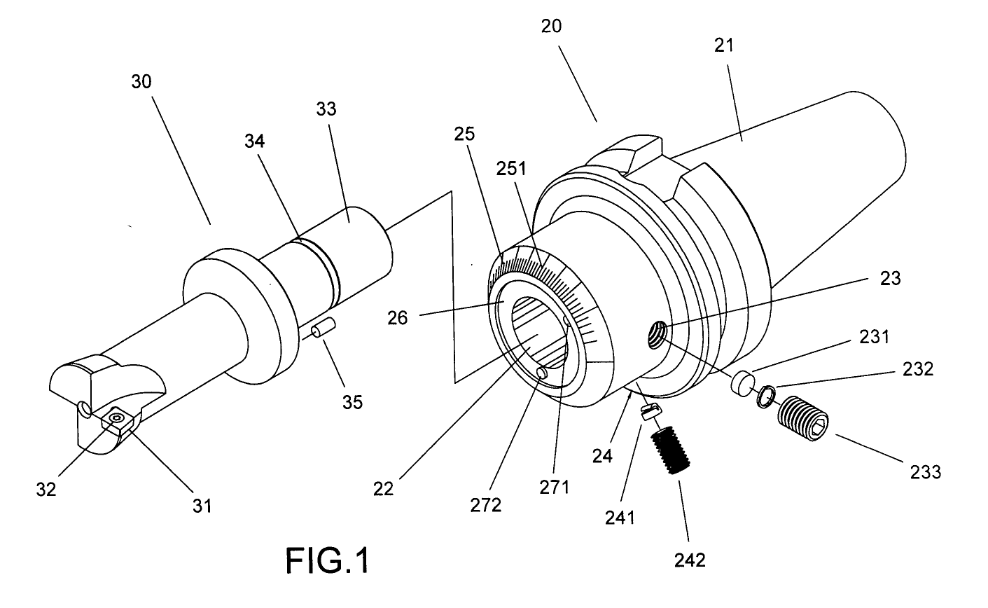

Referring to FIG. 1 to FIG. 3, a micro-adjustable boring bar provided by the present invention includes an adapter 20 and a boring bar body 30. Wherein:

Said adapter 20 has a BT40 tapering spindle 21 at one end and a micro-eccentric bore 22 at another end, wherein the offsetting is about 0.1 mm, and a securing threaded hole 23 is set upon at the opposite side of the eccentricity side for sequentially holding a limiting block 231 and an elastic trip latching into the thread of the threaded hole 23 for preventing the limiting block 231 for falling out, and a screw 233 securing in from the outside, and a locating threaded hole 24 is built upon the side of said micro-eccentric bore 22 and kept an angle with said securing threaded hole 23 for holding an elastic locating block 241 and a screw 241 securing in, and one open end of said adapter 20 is appeared into a frustum with a pyramidal face 25, and a graduations 251 are built on it, a circular recess 26 is set upon the front end of said adapter 20, in which two limiting pins are embedded respectively so as to form limitation points 271 272.

Said boring bar body 30 has a tool rest at one end for securing a tool bit 32 on, and a pivoting shaft 33 at the another end for plugging into said micro-eccentric bore 22 of said adapter 20, and coordinating to said securing threaded hole 23 and said locating threaded hole 24, a V-shaped ring groove 34 is built upon the proper position of said pivoting shaft 33 for catching the elastic locating block 241 and the limiting block 231 in, and a pin is embedded on the shoulder end of said pivoting shaft 33 coordinating to said limitation points 271 272 working as limiting pin 35.

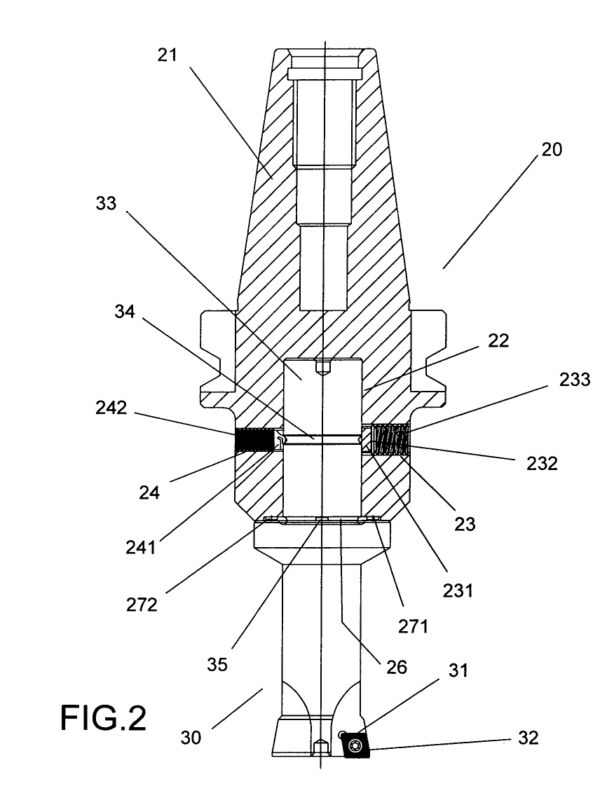

Said elastic locating block 241, as shown best in FIG. 1 and FIG. 2, extends a hook cantilever at front end and the supported joint is at tip end.

Combining and Locking the Adapter and Boring Bar Body:
in reference with FIG. 1 to FIG. 4, when said elastic locating block 241 is pressed into the V-shaped ring groove 34 gradually by securing the screw 242, the tighter the screw 242 secures in, the more power generated by the distortion of the elastic hook cantilever head of the elastic locating block 241 is saved, the distortion is generated surrounding the supported joint as a central point, due to the supported joint placed at top side, so the saved power tends to generate an upward moment pivoting at said supported joint serving as a fulcrum to create an upward pushing force, thereby the boring bar body 30 is joined with the adapter 20 more tightly; additionally, said securing screw 233 securing in from the securing threaded hole 23 presses the limiting block 231 to catch in the V-shaped ring groove 34, so that said boring bar body 30 are fastened into a whole body whatever in both axial and radial directions, further to improve the whole body's rigidity.

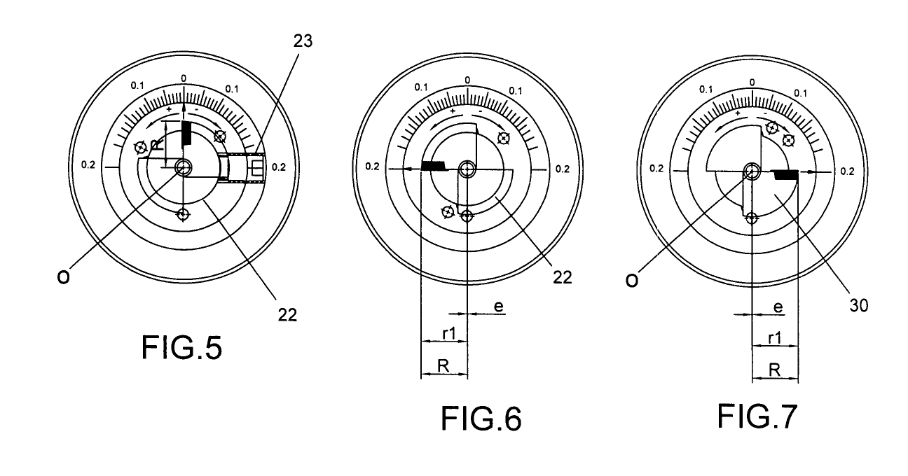

The Description of Micro-Adjustment the Range of the Size of Boring Hole:
1. home (zero) position: referring to FIG. 5, the tip of cutter edge of the present invention is at home (zero) position, the axis of the micro-adjustment bore 22 is on the left of the rotation axis of the adapter 20, such as the opposite side of said securing threaded hole 23, in this position the tip end of the cutter edge is oriented to the North right-cross to the level and said securing screw 233, hence the distance from the tip end of the cutter edge to the rotation axis just equals the turning radius r of the boring bar, in this embodiment the diameter of the boring bar is Φ25 mm, so Φ=12.5 mm the tip end of the cutter edge is at home position.
2. Adjusting the boring hole into maximum size: referring to FIG. 6, when the tip end of the cutter edge is turned 90 degrees in anticlockwise, such as laying on the side of the offset to the micro-adjustment bore 22, therefore the radius of boring hole R=eccentricity e+turning radius r1 of boring bar, in this embodiment a Φ25 mm boring bar is employed, the eccentricity e is 0.1 mm, the rotation radius r1 is 12.5 mm, the radius of boring hole R is 12.6 mm, the maximum size of the boring hole is 25.2 mm.
3. Adjusting the boring hole into minimum size: referring to FIG. 7, when the tip end of the cutter edge is turned 90 degrees in clockwise from home position, such as laying on the left side to the rotation axis side, because the central axis of the boring bar body 30 is located on the left side of the rotation axis, the size of the boring hole is decreased, the radius of the boring hole R=rotation radius of the boring bar body r1−eccentricity e, in this embodiment, boring hole's radius R=12.5 mm−0.1 mm=12.4 mm, the minimum size of the boring hole is 24.8 mm, reduced 0.2 mm than the original size.
So according to above-description, in the embodiment of the present invention the eccentricity 0.1 mm can make 0.2 mm change in size of the boring hole in increasing or decreasing from the original size, so as to enable the present invention to more practicality.

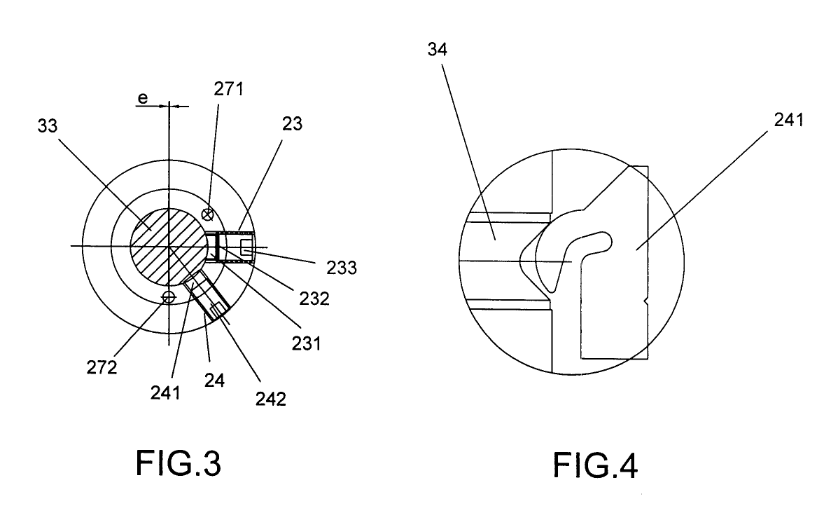

Constant Dynamic Balance:
referring to FIG. 3, due to the micro-adjustment device designed into pivoting adjustment, there are any mass changed in radial as micro-adjusting, so whatever adjusting said boring bar body 30 in the adapter 20, the assembly of boring bar set is kept in constant dynamic balance, therefore we can say that turning the boring bar body 30 in the adapter 20 would not damage the dynamic balance of the whole boring tool set, the dynamic balance is always kept in the best condition.

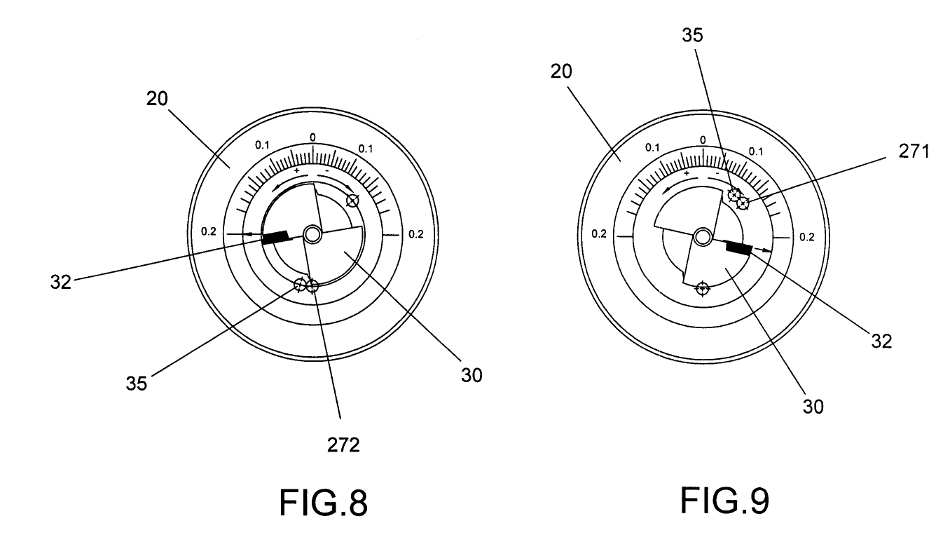

Safety Device:
referring to FIG. 2, said boring bar body 30 and said adapter 20 is fastened together by securing the screw 233 in to press upward the limiting block 231, if there are not any limitation points built upon, if the operator forgets fastening the securing screw 231 after micro-adjusting the boring bar body 30, the boring bar body 30 will stop spinning relatively to the work piece at the moment of the tool bit 32 touching the work piece, and a little bit moved, further to bring up the boring bar body 30 is span at high speed in said micro-adjustment bore 22 of the adapter 20 with relative friction, more specially, under the affect at 10000 to 20000 r/m such high speed relative friction, the heat will weld the boring bar body 30 and the micro-adjustment bore 22 together so as to damage them at all; referring to FIG. 8 and FIG. 9, they show a range of moving of pin 35 limited, such as the range of adjustment of boring bar tool, therein FIG. 8 shows the positive limitation of micro-adjustment, and FIG. 9 is showing the negative limitation of micro-adjustment, so when the boring bar is micro-adjusted in positive or negative direction, the two limiting points can serve as the safety points of the pin 35; when the securing screw 233 is not forgot to be secured after micro-adjusting, the tool bit 32 of the boring bar body 30 is touching against the work piece as running machine, the friction will make the boring bar body 30 stop spinning firstly relative to the work piece, and turn to the negative limitation—limiting pin 271 in clockwise and stop at there, as shown best in FIG. 9, then the boring bar body 30 is driven to spin again relative to the work piece synchronously, meanwhile due to the tool bit 32 located at negative limitation, the boring hole's size is decreased a bit than the desired boring size, so the tool bit 32 will not be damaged, in this embodiment, if the desired boring size is designed into Φ25.1 mm, in practice the hole of work piece should be bored into Φ24.9˜Φ25 mm, in this case, the tip end of the boring bar body 30 is reduced to Φ24.8, and is kept in there to run synchronous cutting, therefore the tool bit 32 will not strike the work piece to occur damage, hence the tool bit 32 is protected, meanwhile the phenomenon of welding the boring bar body 30 and the micro-adjustment bore 22 is efficiently avoided.

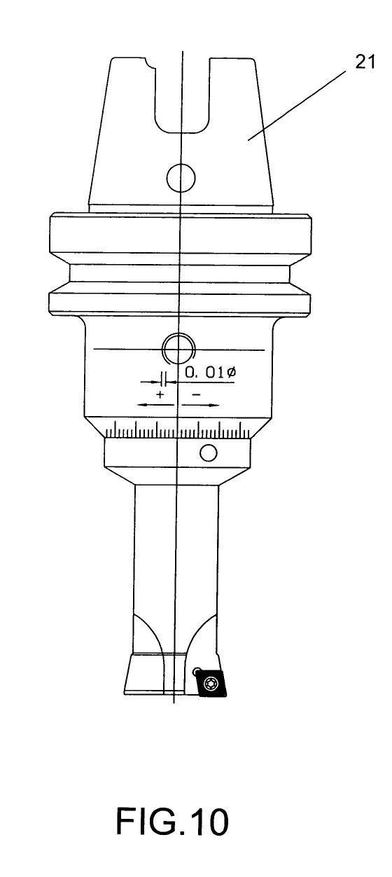

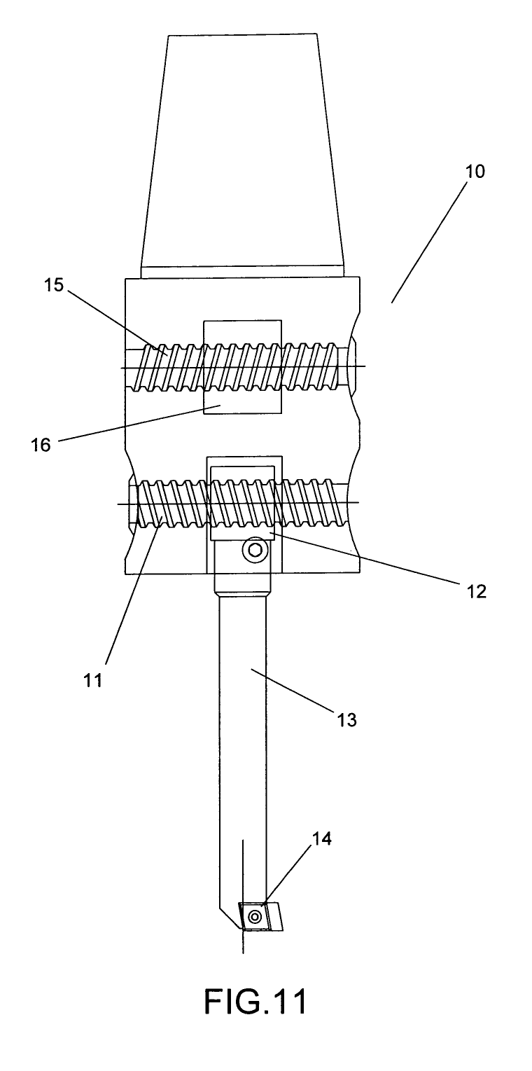

The Best Embodiment of High Spinning Cut:
referring to FIG. 10, it is an embodiment of the present invention, wherein the tapered plug 21 is designed to HSK63A so that the cutting speed can be improved to 20000 rpm, instead of prior BT40 at 10000 rpm, in order to employ on a precision high speed machine coordinately to improve the accuracy of boring hole, meanwhile avoid the precision high speed machine from no matching cutter tool.

In accordance with above-described, the present invention has excellent practicality whatever in working safety and tool bit protection, and fastening boring bar and adapter, and the whole cutter tool's rigidity, and in the constant dynamic balance base on the eccentric micro-adjustment principle, and its lower production cost—about one sixth of the prior art.

1. A micro-adjustable boring bar comprising a boring bar body and an adapter, wherein said adapter has a BT40 tapering spindle at one end and a micro-eccentric bore with a little bit offsetting at another end, and a securing threaded hole is set upon at opposite side of eccentricity side for sequentially holding a limiting block and an elastic trip and a screw securing in from the outside, and a locating threaded hole is built upon the side of said micro-eccentric bore and kept an angle with said securing threaded hole for holding an elastic locating block and a screw securing in, and one open end of said adapter is appeared into a frustum with a pyramidal face, and a graduations are built on it; said boring bar body has a tool rest at one end for securing a tool bit on, and a pivoting shaft at the another end for plugging into said micro-eccentric bore of said adapter, and coordinating to said securing threaded hole and said locating threaded hole, a V-shaped ring groove is built upon the proper position of said pivoting shaft for catching the elastic locating block and the limiting block in.

2. A micro-adjustable boring bar as claimed in claim 1, wherein a circular recess is set upon the front end of said adapter, in which two limiting pins are embedded respectively in proper positions to form a pair of limitation points, coordinating to the two limiting pins, a pin is embedded on the shoulder end of said pivoting shaft of said boring bar body.

3. A as claimed in claim 1, wherein said elastic locating block extends a hook cantilever at front end from the top end and the supported joint is at tip end, as pressed down, it can generate upward elastic restoring force.
